(19) United States
(12) Patent Application Publication
(10) Pub. No.: US 2015/0273474 A1
(43) Pub. Date: Oct. 1, 2015

(54) GYRATORY CRUSHER BEARING

(71) Applicant: SANDVIK INTELLECTUAL PROPERTY AB, Sandviken (SE)

(72) Inventors: Bengt-Arne Eriksson, Svedala (SE); Mikael M. Larsson, Eslov (SE); Patric Malmqvist, Svedala (SE)

(21) Appl. No.: 14/432,841

(22) PCT Filed: Aug. 22, 2013
(86) PCT No.: PCT/EP2013/067454

§ 371 Date: Apr. 1, 2015

(30) Foreign Application Priority Data
Oct. 2, 2012 (EP) 12186997.8

(51) Int. Cl. B02C 2/06; F16C 35/02

(52) U.S. Cl. CPC B02C 2/06; F16C 35/02

(57) ABSTRACT

A gyratory crusher annular bearing is mountable about an upper region of a gyratory crusher main shaft. The bearing has a bearing surface for positioning around an outer surface of the main shaft and a mounting surface for positioning towards a frame part of the gyratory crusher. The annular bearing is maintained in a fixed position relative to the rotatably mounted main shaft by at least one mounting formation.

### FIELD OF INVENTION

The present invention relates to a gyratory crusher bearing for positioning at an upper region of a crusher main shaft, the bearing configured to support gyration of the main shaft about its longitudinal axis.

### BACKGROUND ART

Gyratory crushers are used for crushing ore, mineral and rock material to smaller sizes. Typically, the crusher comprises a crushing head mounted upon an elongate main shaft. A first crushing shell is mounted on the crushing head and a second crushing shell is mounted on a frame such that the first and second crushing shells define together a crushing gap through which the material to be crushed is passed. A driving device is arranged to rotate an eccentric assembly about the lower portion of the shaft so as to cause the crushing head to perform a gyratory pendulum movement and crush the material introduced in the crushing gap.

The main shaft is typically supported at both its upper and lower ends. Various different types of lower bearing assemblies have been proposed. In particular, US 2009/0008489 discloses a hydraulically adjustable cone crusher in which an axial bearing assembly comprises a hydraulic adjustment cylinder for adjusting the setting of the crusher. U.S. Pat. No. 4,919,349 discloses a gyratory crusher having a dual seal arrangement that utilises forced air and a gasket arrangement to block contaminants entering the crusher. SU 897280 describes a cone crusher that has a step cup bearing to absorb and transmit the crushing force of the crusher head.

The crusher main shaft is also journalled at its uppermost end by a top bearing. An example top bearing is disclosed in U.S. Pat. No. 1,748,102 in which a wear ring is retained in an intermediate position between a sleeve surrounding the main shaft and a floating bushing positioned against a central boss of a supporting spider forming a part of the gyratory crusher topshell.

Due to the high performance demands of modern crushers, appreciable wear is a common problem underneath the housing of the top bearing at the region of the topshell. This wear requires operators to weld the worn region which changes the bearing surface and indeed the bearing location. This in turn creates stress concentrations at the bearing and the topshell support frame, which in turn results in accelerated wear of various components and ultimately damage to the crusher.

There is therefore a need for an improved top bearing for a gyratory crusher that avoids premature wear of the support housing at the topshell.

### SUMMARY OF THE INVENTION

It is an object of the present invention to provide a gyratory crusher bearing that protects the top bearing housing from wear caused by the gyratory pendulum movement of the main shaft at the topshell.

The objective is achieved by providing a wear part bearing or wear ring releasably attachable to an upper region of the topshell frame that is capable of effectively and efficiently absorbing and transmitting frictional forces imparted by contact with the gyrating main shaft. The bearing of the present invention is configured for positioning at a lower region of a central boss of the support spider that extends across the topshell of the gyratory crusher frame and is positioned about the uppermost end of the main shaft. The present bearing is releasably attached to the support spider at the central boss and is mounted rigidly so as to effectively absorb and transmit the torque forces induced by the main shaft. As the bearing is anchored at the support spider via a mounting that is distributed circumferentially over the bearing, any unwanted stress concentrations at the bearing housing are obviated.

According to a first aspect of the present invention there is provided a gyratory crusher annular bearing mountable about at an upper region of a gyratory crusher main shaft, the bearing comprising: a bearing surface for positioning around an outer surface of the upper region of the main shaft; a mounting surface for positioning towards a region of a frame part of the gyratory crusher, the frame part surrounding at least a portion of the upper region of the main shaft; characterised by: at least one mounting formation to allow releasable mounting of the bearing at the frame part in substantially fixed position relative to the rotatably mounted main shaft.

Optionally, the bearing further comprises an annular disc-like body to project radially outward from the outer surface of the main shaft; and a flange extending transverse or perpendicular to the disc-like body in a direction to be aligned substantially parallel with an axis of the main shaft. Preferably, the flange projects upwardly from the disc-like body and is positioned towards an inner radius of the bearing. Optionally, the bearing further comprises an annular shoulder extending radially inward from the disc-like body. Optionally, an uppermost region of the flange comprises an annular seating neck to mount a sealing gasket between the main shaft and the frame part.

Preferably, the mounting formation comprises a plurality of holes spaced circumferentially around the bearing. Optionally, the bearing comprises eight bore holes evenly spaced circumferentially around the annular disc-like body. According to further embodiments, the mounting formation may comprise slots, channels or grooves that allow the bearing to be releasably engaged with projections extending from the central boss. Alternatively, the bearing may comprise upwardly extending projections configured to engage into grooves or channels recessed at the frame part for releasable attachment. According to further embodiments, the bearing comprises screw threads configured to cooperate with corresponding screw threads formed on the frame part to allow the bearing to be rotated and screwed into substantially fixed position at the frame part.

According to a second aspect of the present invention there is provided a gyratory crusher comprising: a frame defining an internal crushing zone, the frame having an upper frame and a lower frame; a rotatably mounted main shaft extending through the crushing zone; an annular bearing comprising: a bearing surface for positioning around an outer surface of an upper region of the main shaft; a mounting surface for positioning towards a region of a frame part of the upper frame, the frame part surrounding at least a portion of the main shaft such that at least a part of the bearing is positioned between the main shaft and a region of the frame part; characterised by: at least one mounting formation to allow releasable mounting of the bearing at the frame part in substantially stationary position relative to the rotatably mounted main shaft.

Preferably, the frame part comprises a central boss of a support spider forming an upper part of the upper frame. Preferably, the bearing is releasably mounted to the central boss. Preferably, the crusher may further comprise a plurality of bolts to secure the bearing to the central boss. Preferably, the bearing is attached directly to the central boss. Alternatively, the bearing maybe attached to the frame part via an intermediate mounting that is in turn releasably or permanently attached to the frame part. The intermediate mounting maybe configured to allow the bearing to be releasably clipped and unclipped at the frame part via conventional interconnections including for example male and female connections, tongue and groove and snap-click connections.

Preferably, the bearing is positioned at a lowermost end of the central boss. Optionally, the lowermost end of the central boss comprises an annular recess having a shape profile complementary to a shape profile of a region of the bearing such that the bearing is at least partially accommodated within the annular recess.

Optionally, at least part of the bearing surface is aligned transverse to the outer surface of the main shaft and is inclined inwardly in a direction from a lower region to an upper region of the main shaft.

Preferably, the crusher further comprises a top bushing and a sealing gasket, the sealing gasket positioned, in the axial direction of main shaft, intermediate the top bushing and the annular bearing.

### BRIEF DESCRIPTION OF DRAWINGS

A specific implementation of the present invention will now be described by way example only and with reference to the following drawings in which:

FIG. 1 is a cross-sectional side view of a gyratory crusher having a main shaft supported at its upper end by a top bearing assembly mounted about the upper end of the main shaft according to a specific implementation of the present invention;

FIG. 2 is a magnified view of the upper region of the crusher main shaft and bearing assembly of the gyratory crusher of FIG. 1;

FIG. 3 is an underside perspective view of the bearing of FIG. 2;

FIG. 4 is an upper perspective view of the bearing of FIG. 3;

FIG. 5 is a cross-sectional side view of an upper region of a crusher main shaft and a bearing assembly of a gyratory crusher according to a further specific implementation of the present invention.

### DETAILED DESCRIPTION OF PREFERRED EMBODIMENT OF THE INVENTION

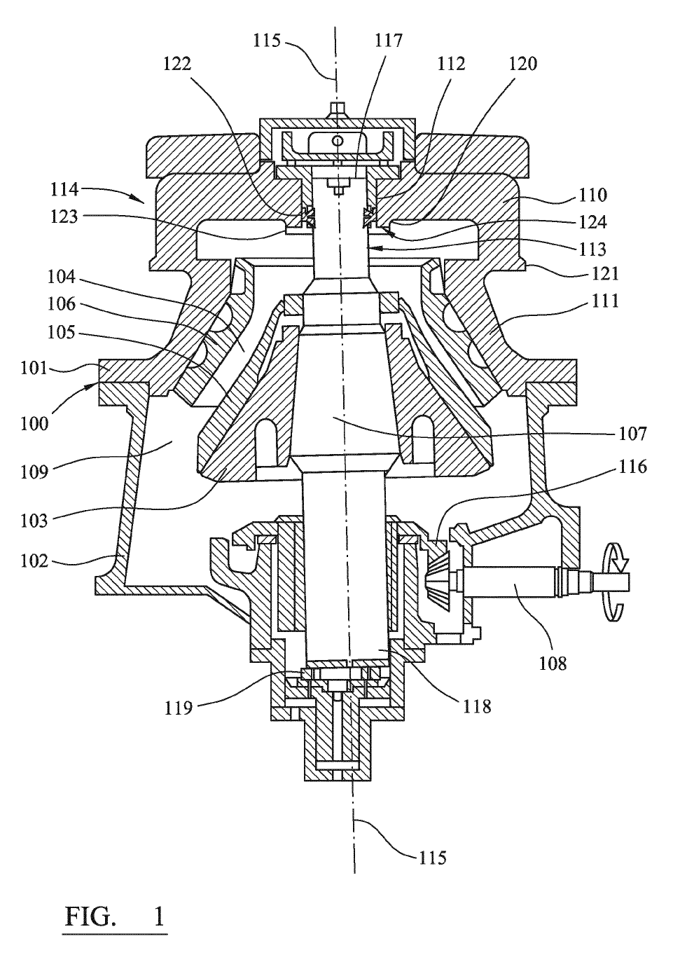

Referring to FIG. 1, a crusher comprises a frame 100 having an upper frame 101 and a lower frame 102. A crushing head 103 is mounted upon an elongate shaft 107. A first crushing shell 105 is fixably mounted on crushing head 103 and a second crushing shell 106 is fixably mounted at top frame 101. A crushing zone 104 is formed between the opposed crushing shells 105, 106. A discharge zone 109 is positioned immediately below crushing zone 104 and is defined, in part, by lower frame 102.

Upper frame 101 is further divided into a topshell 111, mounted upon lower frame 102 (alternatively termed a bottom shell), and a support spider 114 that extends from topshell 111 and represents an upper portion of the crusher. The spider 114 comprises two diametrically opposed arms 110 that extend radially outward from a central boss 120 positioned on a longitudinal axis 115 extending through frame 100 and the gyratory crusher generally. Arms 110 are attached to an upper region of topshell 111 via an intermediate annular flange 121 that is centred around longitudinal axis 115. Typically, arms 110 and topshell 111 form a unitary structure and are formed integrally.

A drive (not shown) is coupled to main shaft 107 via a drive shaft 108 and suitable gearing 116 so as to rotate shaft 107 eccentrically about longitudinal axis 115 and to cause crushing head 103 to perform a gyratory pendulum movement and crush material introduced into crushing gap 104. An upper end region of a shaft 113 comprises a cylindrical outer surface 113. A very uppermost end 117 of shaft 107 is maintained in an axially rotatable position by a top bushing 112 positioned intermediate main shaft region 113 and an upper region of central boss 120. Similarly, a bottom end 118 of shaft 107 is supported by a bottom-end bearing assembly 119.

Gyrational movement of shaft 107 is further supported by an annular bearing 123 mounted at a lower region of central boss 120. Bearing 123 is secured to the lower annular face 124 of boss 120 and is retained in a substantially fixed position relative to moveable shaft 107. Bearing 123, in turn, provides a mount for a sealing gasket 122 positioned intermediate bearing 123 and top bushing 112 in the longitudinal axis direction 115.

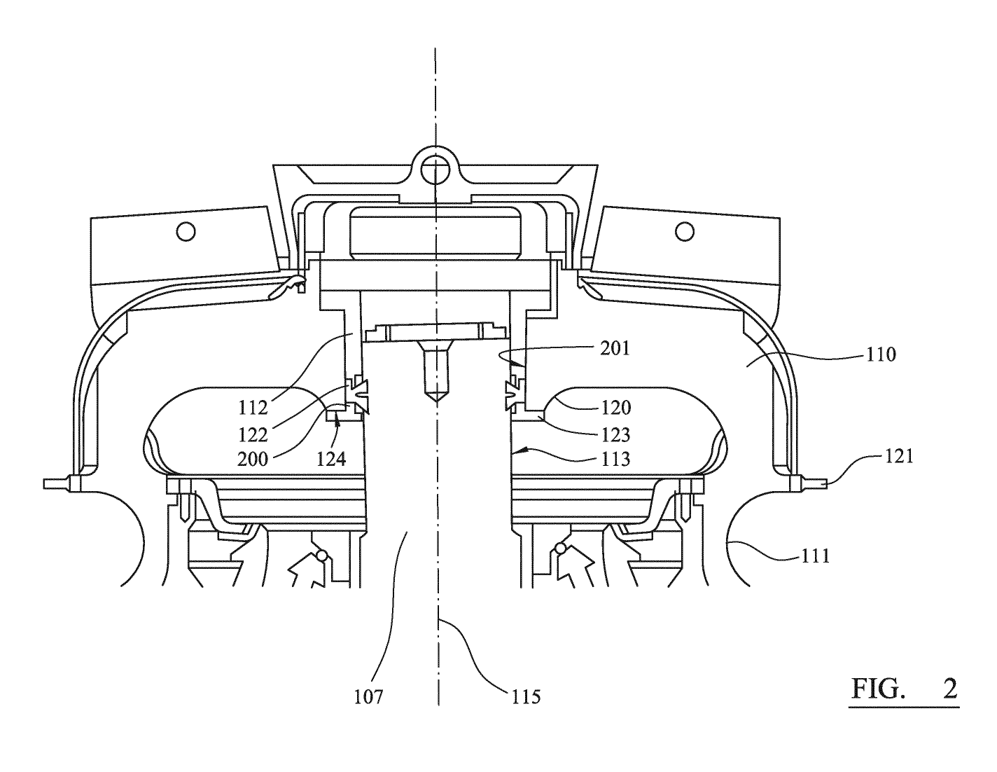

Referring to FIG. 2, bearing 123 comprises a generally annular disc-like body with an annular flange 200 extending upwardly from the disc-like body in the axial direction 115. With this configuration, the main body of bearing 123 is positioned directly below boss 120 whilst flange 200 is positioned in a radial direction intermediate a lower region of boss 200 and the outer surface 113 of shaft 107. Bearing 123 may be considered to represent a lowermost complement part of a top-end bearing assembly. That is, the intermediate sealing gasket 122 is effectively sandwiched between top bushing 112 and the annular disc-like bearing 123.

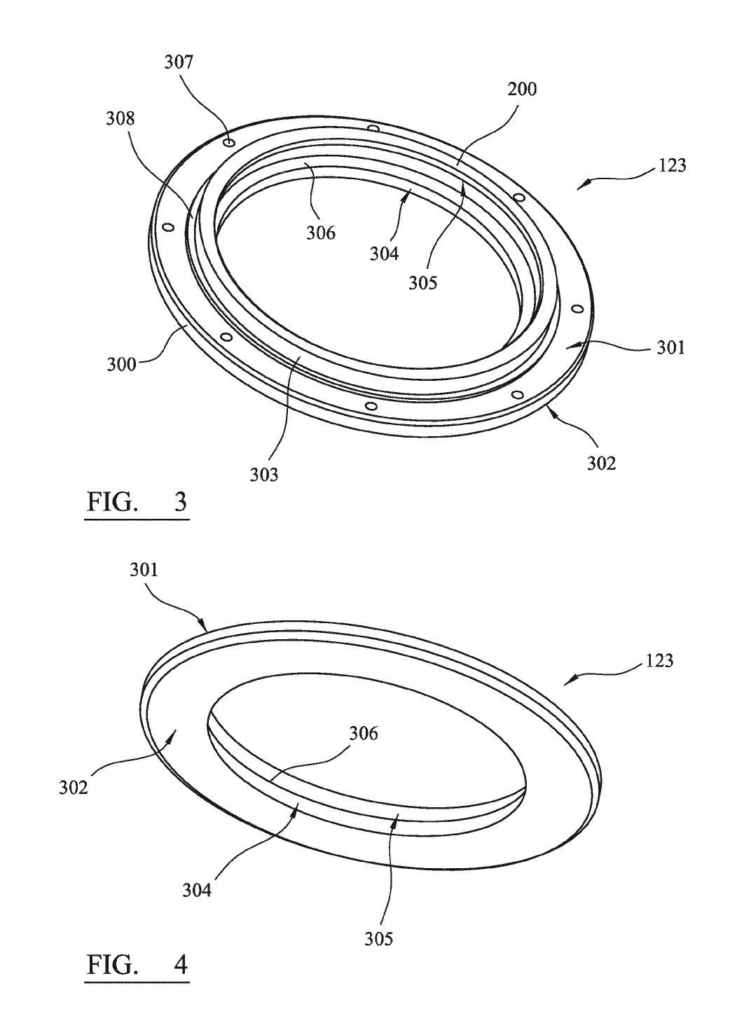

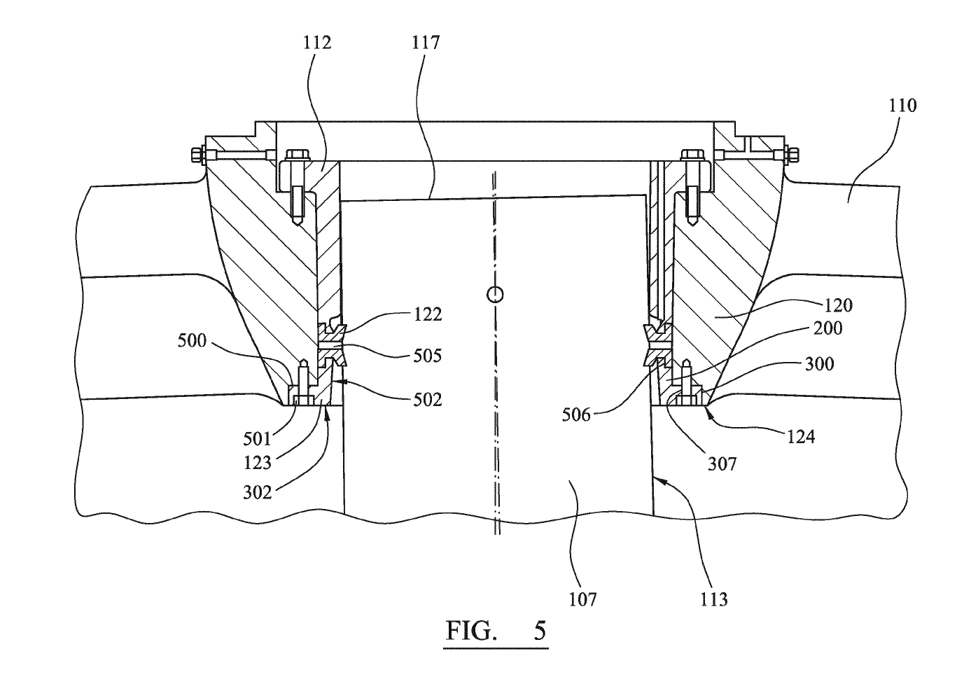

Referring to FIGS. 3 and 4, bearing 123 comprises a bearing surface 304, 305 intended to be positioned towards, and in mating contact with, outer surface 113 of main shaft 107. According to the specific implementation, bearing surface 304, 305 is divided in the axial direction into two halves by a shoulder 306 that projects radially inward from axially projecting flange 200. Shoulder 306 provides a means to seat the intermediate sealing gasket 122 in close fitting contact adjacent outer surface 113 of main shaft 107.

Flange 200 projects perpendicular to the main disc-like body 300 of bearing 123 towards its radially innermost circumferential edge. Disc-like body 300 comprises a first upward facing surface 301 and an opposed downward facing surface 302 when bearing 123 is mounted in position during normal use at boss surface 124. A plurality of bore holes 307 extend through disc-like body 300 and are uniformly distributed circumferentially around body 300. Bore holes 307 are sized to receive suitable anchorage bolts for releasable attachment of bearing 123 to central boss 120. Flange 200 comprises a short cylindrical configuration having a mounting surface 303 orientated to be outward facing relative to longitudinal axis 115. Cylindrical surface 303 and upward facing annular surface 301, in combination, provide mounting surfaces for positioning in contact with the lowermost region 124 of central boss 120. That is, surface 303 is configured for positioning in contact with the inward facing cylindrical surface 201 of boss 120 and annular surface 301 is configured for positioning against annular surface 124 of boss 120.

FIG. 5 illustrates a further specific implementation of the present invention. Bearing 123 according to the further embodiment is configured to sit, at least partially, within a recess 500 machined into the underside surface 124 of boss 120. Bearing 123 comprises the same disc-like main body 300 as illustrated in FIGS. 3 and 4. An axially extending flange 200 also extends from the radially innermost region of main body 300. FIG. 5 further illustrates bearing 123 secured in substantially stationary position at boss 120 via a plurality of attachment bolts 501 secured through the through-bores 307 and embedded upwardly into the lower region of boss 120, as with the embodiment described with reference to FIGS. 1 to 4. When attached in position, the bearing surface 502 of bearing 123 tappers radially inward in a direction from a lower to upper end of the main shaft 107. An upper region 506 of flange 200 comprises a neck portion to interface and mount the sealing gasket 122. Gasket 122 is further retained in position by a stop projection 505. Sealing gasket 122 is further retained in position by top bushing 112 that is in turn mounted in stationary position at boss 120.

As the lower surface 124 of boss 120 is machined to create the annular stepped region 500, entire bearing 123 is capable of mounting within the outer profile of boss 120 such that the downward facing surface 302 of bearing 123 is aligned coplanar with the lowermost downward facing surface 124 of boss 120. As will be appreciated, the embodiment described with reference to FIGS. 1 to 4 may also comprise a boss 120 having a machined and lowermost recessed region 500 to accommodate at least a part of bearing 123.

Referring to both embodiments, and in use, bearing 123 is configured to absorb and transmit to spider 114, and ultimately into topshell 111, the torsional forces induced by the rotating main shaft 107. Positioning bearing 123 at the lowermost region of boss 120 effectively protects the lowermost surface 124 from wear which would otherwise require repair, typically involving welding. Via attachment of bearing 123 to boss 120 using releasable bolts 501, bearing 123 and gasket 122 maybe quickly and conveniently removed and replaced to ensure continued optimum performance of the entire crusher.

According to further specific embodiments, bearing 123 maybe retained in a substantially fixed position at a lower region of boss 120 by any suitable releasable attachment assembly including in particular cooperating screw threads provided at bearing 123 and boss 120. Further, an intermediate mounting part maybe secured to boss 120 to form a mount for bearing 123. Bearing 123 maybe releasably held at the intermediate mounting by any suitable attachment means including bolts, pins, screws or screw threads. Alternatively, bearing 123 maybe releasably clipped in position at the intermediate mounting.

1. A gyratory crusher annular bearing mountable about at an upper region of a gyratory crusher main shaft, the bearing comprising:
a bearing surface arranged for positioning around an outer surface of the upper region of the main shaft;
a mounting surface arranged for positioning towards a region of a frame part of the gyratory crusher, the frame part surrounding at least a portion of the upper region of the main shaft; and
at least one mounting formation to allow releasable mounting of the bearing at the frame part in a substantially fixed position relative to the rotatably mounted main shaft.

2. The bearing as claimed in claim 1, further comprising an annular disc-like body projecting radially outward from the outer surface of the main shaft; and a flange extending transverse or perpendicular to the disc-like body in a direction to be aligned substantially parallel with an axis of the main shaft.

3. The bearing as claimed in claim 2, wherein the flange projects upwardly from the disc-like body and is positioned towards an inner radius of the bearing.

4. The bearing as claimed in claim 2, further comprising an annular shoulder extending radially inward from the disc-like body.

5. The bearing as claimed in claim 2, wherein an uppermost region of the flange includes an annular seating neck to mount a sealing gasket between the main shaft and the frame part.

6. The bearing as claimed in claim 1, wherein the mounting formation includes a plurality of holes spaced circumferentially around the bearing.

7. A gyratory crusher comprising:
a frame defining an internal crushing zone, the frame having an upper frame and a lower frame;
a rotatably mounted main shaft extending through the crushing zone; and
an annular bearing including a bearing surface arranged for positioning around an outer surface of an upper region of the main shaft; a mounting surface arranged for positioning towards a region of a frame part of the upper frame, the frame part surrounding at least a portion of the main shaft such that at least a part of the bearing is positioned between the main shaft and a region of the frame part; and at least one mounting formation to allow releasable mounting of the bearing at the frame part in substantially stationary position relative to the rotatably mounted main shaft.

8. The crusher as claimed in claim 7, wherein the frame part includes a central boss of a support spider forming an upper part of the upper frame.

9. The crusher as claimed in claim 8, wherein the bearing is releasably mounted to the central boss 120.

10. The crusher as claimed in claim 9, further comprising a plurality of bolts to secure the bearing to the central boss.

11. The crusher as claimed in claim 8, wherein the bearing is attached directly to the central boss.

12. The crusher as claimed in claim 8, wherein the bearing is positioned at a lowermost end of the central boss.

13. The crusher as claimed in claim 12, wherein the lowermost end of the central boss comprises includes an annular recess having a shape profile complementary to a shape profile of a region of the bearing such that the bearing is at least partially accommodated within the annular recess.

14. The crusher as claimed in claim 7, wherein at least part of the bearing surface is aligned transverse to the outer surface of the main shaft and is inclined inwardly in a direction from a lower region to an upper region of the main shaft.

15. The crusher as claimed in claim 7, further comprising a top bushing and a sealing gasket, the sealing gasket positioned, in the axial direction of main shaft intermediate the top bushing and the annular bearing.
